(19) United States
(12) Patent Application Publication
(10) Pub. No.: US 2013/0054477 A1
(43) Pub. Date: Feb. 28, 2013

(54) SYSTEM TO IDENTIFY MULTIPLE COPYRIGHT INFRINGEMENTS

(71) Applicant: Robert STEELE, Santa Monica, CA (US)

(72) Inventor: Robert STEELE, Santa Monica, CA (US)

(21) Appl. No.: 13/594,596

(22) Filed: Aug. 24, 2012

Related U.S. Application Data
(60) Provisional application No. 61/526,946, filed on Aug. 24, 2011.

(51) Int. Cl. G06Q 50/26

(52) U.S. Cl. 705/310

(57) ABSTRACT

A system, a method, and a computer program for determining multiple copyright infringement events, identifying a stopped reporting repeat infringer, identifying a started reporting repeat infringer, and determining if the stopped reporting repeat infringer and the started reporting repeat infringer are using the same computer.

### CROSS REFERENCE TO PRIOR APPLICATIONS

This application claims priority to and the benefit thereof from U.S. Provisional Patent Application No. 61/526,946, filed on Aug. 24, 2011, titled “System to Identify Multiple Copyright Infringements,” the entirety of which is incorporated herein by reference.

### COPYRIGHT NOTICE

The present application includes material that is subject to copyright protection. The copyright owner does not object to the facsimile reproduction of the application by any person as the application appears in the records of the U.S. Patent and Trademark Office, but otherwise reserves all rights in the copyright.

### FIELD OF THE DISCLOSURE

The present disclosure relates to a system, a method, and a computer program for identifying acts of copyright infringement. Specifically, the present disclosure is directed to a system, a method, and a computer program that provides a novel approach to forensically identify repeat infringers.

### BACKGROUND OF THE DISCLOSURE

Digital piracy of copyright material is a substantial, worldwide problem for the music industry. For example, according to the International Federation of the Phonographic Industry (IFPI) Digital Music Report 2011, digital piracy has substantially contributed to the erosion of music industry revenues. The IFPI reports that global recorded music revenues declined by 31% from 2004-2010 as a result of such piracy. The IFPI has found that while some peer-to-peer sharing networks such as Limewire are in decline, the use of other peer-to-peer sharing networks such as BitTorrent are on the rise. Similarly, the Nielsen Company reports that nearly one in four active Internet users in Europe visit unlicensed content sites monthly. Although copyright infringement appears to be widespread, most acts of copyright infringement are carried out by a small number of individuals. In order to combat this problem, governments from around the world are beginning to shift some of the burden to Internet service providers (hereinafter “ISP”) to address acts of piracy occurring on their networks.

Established in 1997, the Digital Millenium Copyright Act (DMCA), which is also known as the “No Electronic Theft” Act, heightened the penalties for copyright infringement on the Internet and established the liability of the providers of on-line services for acts of copyright infringement performed by their users. The Act outlawed the manufacture, sale, or distribution of code-cracking devices used to illegally copy software. The Act states that service providers may not allow the illegal downloading of copyright materials by means of their systems.

In trying to combat peer-to-peer copyright infringement, the music industry, for example, has spent millions of dollars searching for a technology breakthrough to protect copyrighted works. These technologies often include Digital Rights Management (DRM). DRM technologies attempt to prevent digital music player technology from allowing reproduction of the copyrighted works. However, DRM technologies generally suffer from the problem that if a reasonably talented technology person can listen to a music file, then that person can likely find a way to make a copy that does not have the DRM technology. Similarly, problems also exist with multimedia content copy prevention methods that are currently available.

The disclosure provides a novel method, system, and computer program to facilitate the recapture of lost revenue, which results from copyright infringement. In particular, the novel system, method, and computer program facilitate identification of acts of copyright infringement, documentation of the details surrounding the acts of copyright infringement, providing notice of the copyright infringement to ISPs, and presentation of a novel approach to settle and resolve obligations incurred as a result of an identified act of copyright infringement.

### SUMMARY OF THE DISCLOSURE

Accordingly, the present disclosure provides a system, a method, and a computer program that may mine a data stream of infringement data over a period of time, process the mined data to find correlations in the data, and identify specific sets of IP addresses and ports associated with acts of copyright infringement. The system, method, and computer program may be further configured to provide a settlement offer that may be accepted to resolve obligations incurred as a result of an identified act of copyright infringement.

Another aspect of the present disclosure provides a method for forensically identifying repeat infringers, the method comprising: teaching a machine learning algorithm with at least a portion of a first data set, wherein the first data set is associated with a stopped recording repeat infringer; feeding the machine learning algorithm a second data set, wherein the second data set is associated with a started reporting repeat infringer; and, determining if the stopped reporting repeat infringer and the started reporting repeat infringer are using the same computer.

The first data set may include a file list associated with the stopped reporting repeat infringer.

The first data set may include a subset of all file lists associated with the stopped reporting repeat infringer.

The second data set may include a file list associated with the started reporting repeat infringer.

The file list may include the most recent file list associated with the started reporting repeat infringer.

The machine learning algorithm may include Bayesian Network Classification.

The method may also include calculating a probability that the first data set and the second data set are substantially equivalent; and, storing the probability in a data structure.

The method may also include displaying the first data set and the second data set in a split screen format.

Another aspect of the disclosure provides a system for forensically identifying repeat infringers, comprising: a first data gathering module configured to obtain a first file list associated with a stopped reporting repeat infringer; a second data gathering module configured to obtain a second file list associated with a started reporting repeat infringer; and, a comparing module configured to compare the first file list to the second file list; and determine if the stopped reporting repeat infringer and the started reporting repeat infringer are using the same computer.

The stopped reporting repeat infringer and the started reporting repeat infringer may have different IP address-Port number combinations.

The system may also include a calculation module configured to calculate the probability that the first file list and the second file list are substantially equivalent.

The system may also include a display module configured to display the first list and the second list in a split screen format.

Another aspect of the present disclosure provides a computer readable medium including instructions, which when executed by a computer, cause the computer to perform a method for forensically identifying repeat infringers, the instructions comprising: instructions that instruct the computer to teach a machine learning algorithm with at least a portion of a first data set, wherein the first data set is associated with a stopped recording repeat infringer; instructions that instruct the computer to feed the machine learning algorithm a second data set, wherein the second data set is associated with a started reporting repeat infringer; and, instructions that instruct the computer to determine if the stopped reporting repeat infringer and the started reporting repeat infringer are using the same computer.

The first data set may include a file list associated with the stopped reporting repeat infringer.

The first data set may include a subset of all file lists associated with the stopped reporting repeat infringer.

The second data set may include a file list associated with the started reporting repeat infringer.

The file list may include the most recent file list associated with the started reporting repeat infringer.

The machine learning algorithm may include a Bayesian Network Classification.

The computer readable medium may also include instructions that instruct the computer to calculate a probability that the first data set and the second data set are substantially equivalent, and instructions that instruct the computer to store the probability in a data structure.

The computer readable medium may also include instructions that instruct the computer to display the first data set and the second data set in a split screen format.

Additional features, advantages, and embodiments of the disclosure may be set forth or apparent from consideration of the detailed description, drawings and attachment. Moreover, it is to be understood that the foregoing summary of the disclosure and the following detailed description, drawings and attachment are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for identifying multiple copyright infringements.

FIG. 2 shows an example of a process for detecting acts of copyright infringement and identifying repeat infringers.

FIG. 3A shows an example of an infringement notification process, according to principles of the disclosure.

FIG. 3B shows an example of an infringer notification process, according to principles of the disclosure.

FIG. 3C shows an example of a further infringer notification process, according to principles of the disclosure.

FIG. 4 shows an example of a redirect webpage, accords according to principles of the disclosure.

FIG. 5 shows an example of a process for determining whether an identified repeat infringer has stopped reporting acts of infringement.

FIG. 6 shows an example of a process for determining whether a new, or previously unidentified, repeat infringer has started reporting acts of infringement.

FIG. 7 shows an example of a process for maneuvering through a list of repeat infringers and associating a file list with each repeat infringer.

FIG. 8 shows an example of a process for determining whether two different IP address-Port number combinations are associated with the same repeat infringer.

FIG. 9 shows an example of a process for teachings a machine learning algorithm.

FIG. 10 shows an example of a process for applying a machine learning algorithm to an input data set.

FIG. 11 shows an example of a process for sorting and interpreting the output of a machine learning algorithm.

The present disclosure is further described in the detailed description that follows.

### DETAILED DESCRIPTION OF THE DISCLOSURE

The disclosure and the various features and advantageous details thereof are explained more fully with reference to the non-limiting, embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor (ink, a radio frequency (RF) communication link, an infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including nonvolatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

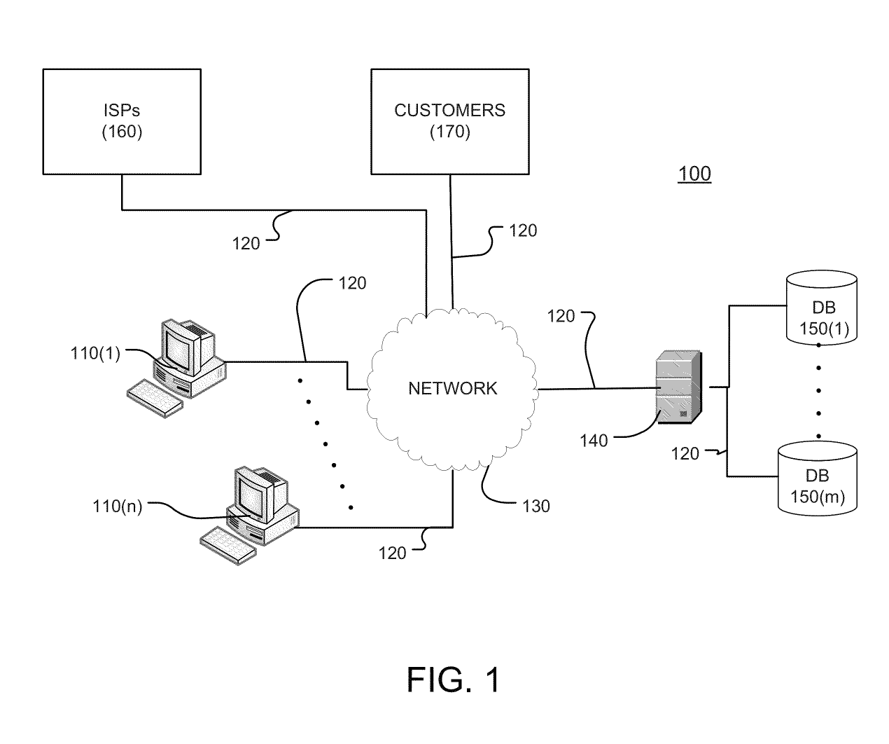

FIG. 1 shows an example of a system 100 for identifying multiple copyright infringements. The system 100 includes a plurality of Peer-to-Peer (P2P) computers 110(1) to 110(n) (where n is a positive, non-zero integer), a network 130, a server (or computer) 140, one or more databases 150(1) to 150(m) (where m is a positive, non-zero integer), one or more ISPs 160, and one or more customers 170. The server 140 and database(s) 150 may be connected to each other and/or the network 130 via one or more communication links 120. The P2P computers 110, the ISPs 160, and the customers 170 may be coupled to the network 130 via communication links 120. The customers 170 may include, for example, but are not limited to, individuals, privately owned entities, corporations, government agencies (e.g., the Department of Justice), or the like. The ISPs 160 may each be provided with a unique login identification and password to access a virtual space allocated to the particular ISP 160, which may include a portion of, or an entire, database 150. Similarly, the customers 170 may each be provided with a unique login identification and password to access a virtual space allocated to the particular customer 170, which may include a portion of, or an entire database 150.

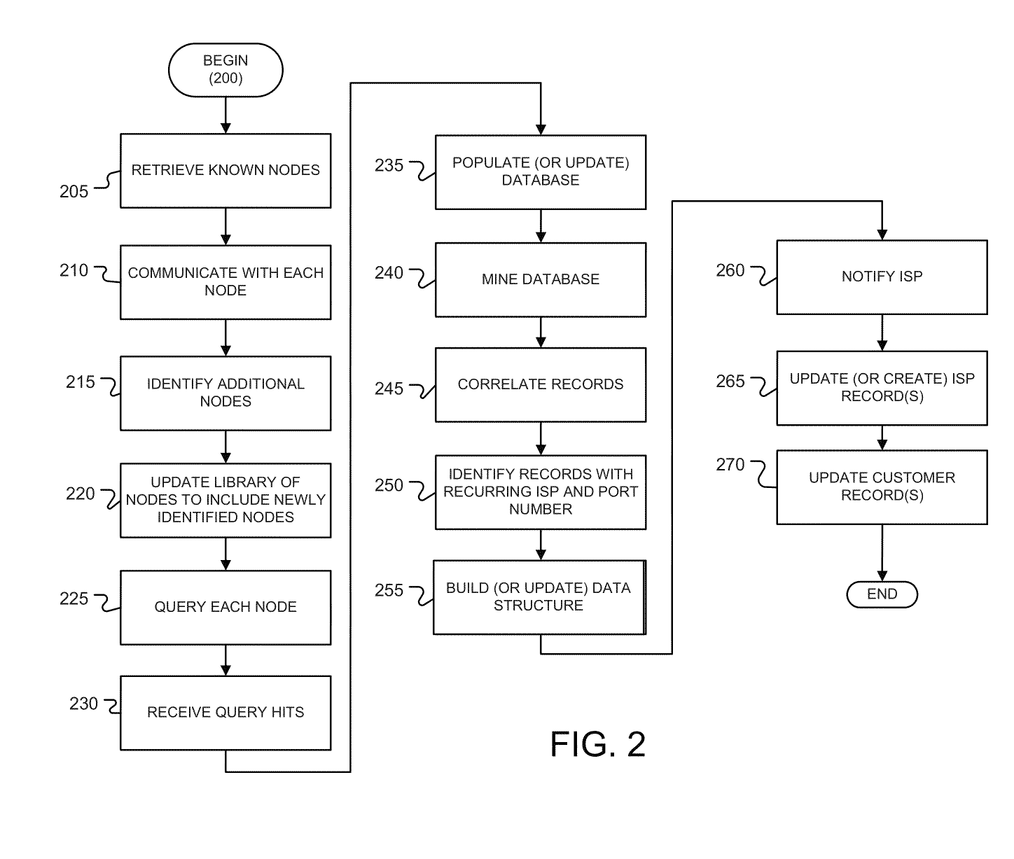

FIG. 2 shows an example of a process 200 for detecting acts of copyright infringement and identifying repeat infringers. The process 200 may be carried out, for example, by the server 140.

The process of FIG. 2 begins at step 205 by retrieving all known nodes in order to generate a library of nodes. A node may include, e.g., any device that is an endpoint of data transmission or reception across a network. The node may be, e.g., the computer associated with an act of infringement (i.e., the infringing computer). The node may be associated with, e.g., an IP address and/or a port. The library of known nodes may be retrieved from, local storage or remote storage. The library of known nodes may be retrieved, e.g., from a BitTorrent network. Then, at step 210, a signal may be sent to each of the nodes (or fewer than all of the nodes) in the library of nodes in an attempt to discover additional nodes. This signal may comprise, e.g., a query for additional nodes.

In response to the query, a response signal comprising, e.g., the results of the query, may be received from each of the nodes. In step 215, the process interprets the response signal and determines if the response signal includes an identification of one or more additional nodes. If one or more additional node are identified, the one or more additional nodes may be added to the library of known nodes in step 220 and stored in, for example, local storage thereby providing the capability to update the library of known nodes.

After updating the library of nodes, step 225 provides that each of the nodes in the updated list of nodes may be queried to determine if the nodes include one or more predetermined files. Such a query may include, e.g., a request to receive a copy of the predetermined file. For purposes of this disclosure, it is contemplated that the predetermined file may include copyrighted material including, for example, a text file, an audio file, a video file, a multimedia file, or the like. The query of step 225 may include a keyword, a number, an alphanumeric character, or the like.

In step 230, one or more query hits may be received from the queried nodes. A query hit may include, e.g., a response to the query that indicates that the node will provide a copy of the copyrighted material. Such a response may thereby constitute an act of copyright infringement. Alternatively, or in addition, each query hit may include, e.g., infringement data. The infringement data may include, e.g., an IP address, a port number, a file name, a time stamp, a software version of the peer-to-peer software used to download (or upload) the copyrighted material, an ISP identifier, or the like. Then, at step 235 a database 150 may be populated with data associated with the received query hit including, e.g., infringement data.

After the database has been populated with the infringement data, the database may be mined in step 240. In particular, each of the records in the database may be retrieved and analyzed or a query may be submitted to the database to return particular records containing infringement data. At step 245, all of the records (or a portion of all records) may be correlated in order to cluster, or group together, all records having a predetermined relationship. The predetermined relationship may be, e.g., a same, or substantially the same, IP address and port number combination (also referred to herein as IP address-port number combination). As a result of the correlating process, it is possible to easily identify all records (or a portion of all records) that have the same, or substantially the same, predetermined relationship in step 250.

In order to facilitate efficient organization and maintenance of the clustered records, one or more data structures may be generated and populated with the identified records having the same, or substantially the same, IP address and port number combination at step 255. The data structure may be, e.g., a table, an array, a list, a linked list, a tree structure, or the like. If a corresponding data structure already exists, then the data structure may be updated with any newly identified records or information.

At step 260, an ISP may be notified when one or more acts of copyright infringement have been detected. Such an ISP may be notified, e.g., when a single act of copyright infringement has been detected. Alternatively, the method could be implemented in a manner that focuses on only notifying an ISP when a repeat infringer has been detected.

A repeat infringer may be detected by monitoring a predetermined threshold associated with the number of entries populating each generated data structure. For example, the method may provide that once a predetermined number (such as, for example, 5, 10, 20, or any positive number greater than 1) of data structure entries are identified that have substantially the same IP address and substantially the same port number, the ISP 160 associated with the IP address may be notified.

The notification may be in the form of a communication such as, for example, an email, a text message, a data transmission, a voice message, a mailed letter, or the like, and may include one or more of the IP address, the port number, and a time stamp. Alternatively, or in addition, the notification may include, e.g., updating a file, a data structure, a record, metadata, or the like, with at least a portion of the infringement data, including one or more of the IP address, the port number, the file name, and the time stamp, which may be accessed by the ISP.

In addition, or alternatively, the ISP may be provided with, e.g., a dashboard that is populated with ISP infringing data. The ISP infringing data may include, e.g., a total number of infringement events (or acts) for a given time period (e.g., a second, a minute, an hour, a day, a week, a month, a year, a time range, a date range, or the like), the total number of unique IP address-port number combinations during the time period, the number of infringement events associated with each unique IP address-port number combination, the infringement data for each infringement event, or the like.

The ISP infringing data may further include reconciliation data. The reconciliation data may include information regarding any payment that may have been received for a particular infringement event, whether the payment was forwarded to a copyright owner (or a proxy, or someone authorized by the copyright owner to receive payment, or the like), the identity of the copyright owner, or the like.

After the ISP 160 has been notified in step 260, the record(s) (or profile) that is/are associated with the particular ISP may be updated with the entries of the associated data structure in step 265. If a record does not exist for the particular ISP, then a record may be created.

A customer notification including customer data may be communicated to the customer 170. Such customer data may be used, e.g., to update customer records in step 270. The customer notification may be in the form of an electronic communication such as, for example, an email, a text message, a data transmission, a voice message, a mailed letter, or the like, and may include the customer data. The customer data may include infringement data for each ISP and/or unique IP address and port number combinations, including, for example: an identification of the ISP, the number of unique IP address and port number combinations, the number of infringing events associated with each unique IP address and port number combination, the file names downloaded or uploaded by each unique IP address and port number combination, the dates and times of each of the infringing events that are associated with each IP address and port number combination, or the like. The customer notification data may further include historical data for each ISP, for each unique IP address and port number combination, for each file name, or the like.

The customer may be provided with e.g., a dashboard that is populated with customer data. The customer data may further include, for example, a total number of infringement events for a given time period (e.g., a second, a minute, an hour, a day, a week, a month, a year, a time range, a date range, or the like), the total number of unique IP address-port number combinations during the time period, the number of infringement events associated with each unique IP address and port number combination, the infringement data for each infringement event, or the like.

The customer data may further include customer reconciliation data. The reconciliation data may include payment information (e.g., payment that may have been received for a particular infringement event), the IP address and port number combination associated with the infringement event, whether the IP address and port number is a repeat offender, whether the ISP has taken any action (e.g., sent a notice to the infringer, redirected infringer's Internet access requests to a redirect webpage, disconnected the infringer, or the like), the nature of the type of action taken, or the like.

According to an aspect of the disclosure, a computer readable medium is provided containing a computer program, which when executed on, e.g., the server 140, causes the process 200 in FIG. 2 to be executed. The computer program may be tangibly embodied in the computer readable medium, comprising one or more program instructions, code segments, or code sections for performing steps 205 through 270 when executed by, e.g., the server 140, and/or the like.

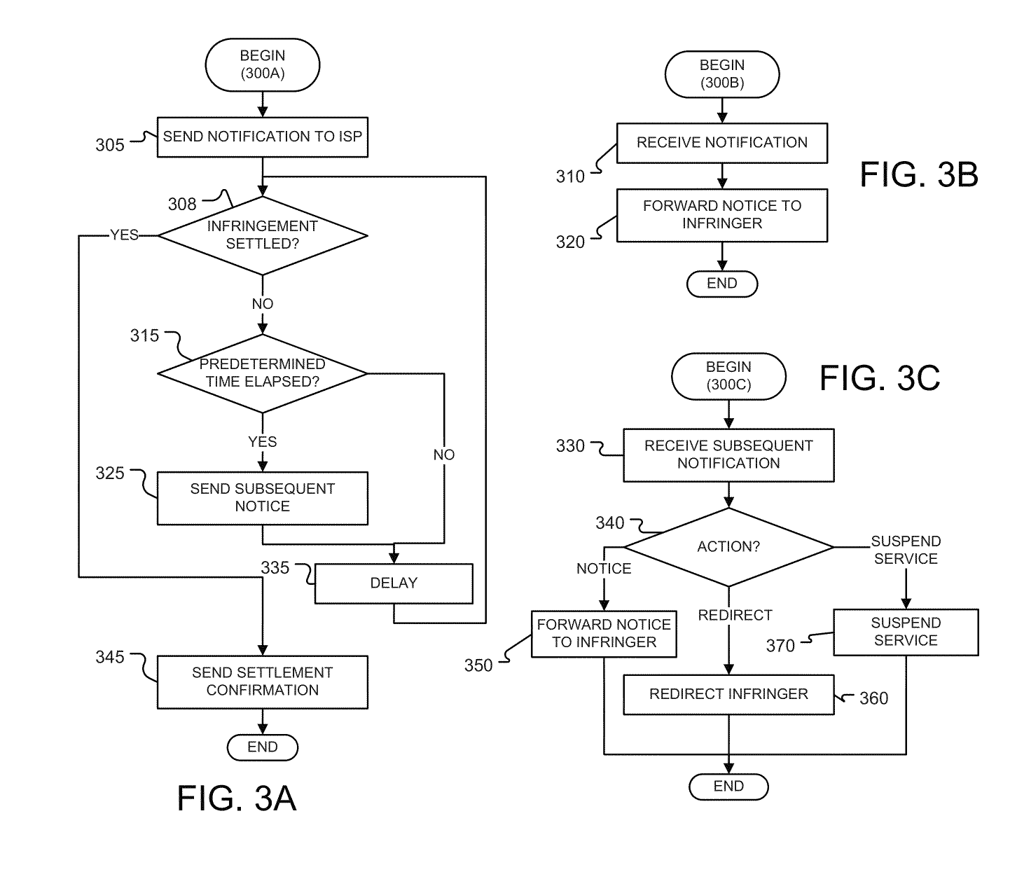

FIG. 3A shows an example of an infringement notification process 300A, according to principles of the disclosure. After an act of infringement has been identified and verified for a particular infringing computer by following, e.g., one or more steps of the process 200 (shown in FIG. 2), an infringement notification may be sent to the ISP that provides service to the infringing computer in step 305. The infringement notification may include, e.g., an email, a text message, a data transmission, a voice message, a written letter, or the like, which includes the ISP address, the port number, and/or a time stamp. Alternatively (or additionally), the infringement notification may include, e.g., updating a file, a table, a record, or the like, with at least a portion of the infringement data, including the IP address, the port number, the file name, and/or the time stamp, which may be accessed by the ISP.

After the infringement notification has been sent to the ISP, a determination may be made as to whether the infringement has been settled by the infringer in step 308. If the infringement is determined to have been settled (YES at step 308), then a settlement confirmation may be sent to the ISP in step 345, otherwise (NO at step 308) a determination may be made as to whether a predetermined time has elapsed (e.g., 1 day, 5 days, 10 days, etc.) in step 315.

If it is determined that the predetermined time has elapsed (YES at step 315), then a subsequent infringement notification may be sent to the ISP in step 325, otherwise (NO at step 315) no action is taken for a time period indicated in step 335. After the expiration of the time period established in step 335, the process may again determine whether the infringement has been settled in step 308. The time period (“delay”) may be substantially equal to, or less than, the predetermined time.

A computer readable medium may be provided containing a computer program, which when executed on, e.g., the server 140 (shown in FIG. 1), causes the process 300A in FIG. 3A to be carried out. The computer program may be tangibly embodied in the computer readable medium, comprising one or more program instructions, code segments, or code sections for performing steps 305 through 345 when executed by, e.g., one or more computers, server 140, and/or the like.

FIG. 3B shows an example of an infringer notification process 300B, according to principles of the disclosure. After an act of infringement has been identified and verified for a particular infringing computer by following, e.g., one or more steps of the process 200 (shown in FIG. 2), an ISP receives an infringement notification in step 310. After an ISP receives an infringement notification in step 310, the ISP may forward an infringer notice to the infringer identified in the infringement notification in step 320. The infringer notice may include, e.g., an email, a text message, a data transmission, a voice message, a mailed letter, or the like. The infringer notice may also include at least a portion of the infringement data including, e.g., an IP address, a port number, the file names downloaded or uploaded by the infringer, a software version of the peer-to-peer software used to download (or upload) the copyrighted material, historical information, an ISP identifier, and/or at least one time stamp associated with an infringing computer.

FIG. 3C shows an example of a further infringer notification process 300C, according to principles of the disclosure. After an act of infringement has been identified and verified for a particular infringing computer, e.g., by following one or more steps of the process 200 (shown in FIG. 2), an ISP may receive a subsequent infringement notification in step 330. The subsequent infringement notification may, e.g., suggest that an ISP take one of a plurality of actions. An ISP may then determine which action to take in response to the message at step 340. The actions may include, e.g., sending a subsequent infringement notice (NOTICE at step 340, then step 350), redirecting the infringer to a redirect webpage (REDIRECT at step 340, then step 360), or suspending service to the infringer (SUSPEND SERVICE at step 340, then step 370).

A computer readable medium may be provided containing a computer program, which when executed on, e.g., the ISP 160 and/or server 140, causes the processes 300B and/or 300C in FIGS. 3B and 3C, respectively, to be carried out. The computer program may be tangibly embodied in the computer readable medium, comprising one or more program instructions, code segments, or code sections for performing steps 310 through 320 and/or 330 through 370 when executed by, e.g., one or more computers, the ISP 160, server 140, and/or the like.

According to an aspect of the disclosure, in the system 100 (shown in FIG. 1), a computer program (or software) may crawl the p2p network(s) network 130, shown in FIG. 1) and communicate with peers that may have files that the system 100 may want to monitor, such as, e.g., unauthorized copies of copyrighted materials. The computer program may retrieve infringement data including, e.g., the file name, the IP address, the timestamp, and the port number from each peer that has a file to be monitored. The computer program may then mine the infringement data and output a list of repeat infringers, which may include, e.g., the number of infringement events, the identified IP address-port number combinations, etc. For example, in communicating with 2,289,948 peers, the ten most popular ports may be displayed in Table 1.

TABLE 1

| Port # | # of occurrences | Probability |
|---|---|---|
| 27016 | 661,009 | 28.87% |
| 6346 | 159,853 | 6.98% |
| 6348 | 12,552 | 0.55% |
| 63460 | 2,244 | 0.10% |
| 6349 | 1,737 | 0.08% |
| 6350 | 1,577 | 0.07% |
| 1 | 1,422 | 0.06% |
| 43795 | 1,178 | 0.05% |
| 17145 | 1,151 | 0.05% |
| 10800 | 1,080 | 0.05% |

In the example set forth in Table 1, where forty-three (43) IP addresses are identified with infringements with the same port number over a partially consecutive sequence of days, there is N % probability that these IP addresses are from the same computer. N varies based on the port. If the IP addresses are rotated between one infringement and the next, there is, e.g., about a 2244/2,289,948 or about 0.1% chance that the same IP address 75,9.73.1 would land on port 63460 after the rotation. Therefore, there is a 99.9% chance that these infringements, displayed in Table 2 are from the same computer.

TABLE 2

| | | | | | | |
|---|---|---|---|---|---|---|
| 1 | GB-9fd5fbf1-a7f7-4e6c-b307- | lost in love | Air Supply - Lost In Love.mp3 | 5/23/11 12:24 PM | 75.9.73.155 | 63460 |
| | fc7d7831e6cc | | | | | |
| 2 | GB-b3273ba3-999b-4392-bb43- | making love out of | Air Supply - Making Love Out of | 5/23/11 12:24 PM | 75.9.73.155 | 63460 |
| | a8cfd729fb04 | nothing at all | Nothing At All.mp3 | | | |
| 3 | GB-bb6881c3-9629-440c-8d03- | two less lonely | Air Supply - Two Less Lonely | 5/23/11 12:24 PM | 75.9.73.155 | 63460 |
| | be087d8db717 | people in the world | People In The World.mp3 | | | |
| 4 | GB-4353c463-bfc7-45ba-b876- | young love | Air Supply - Young Love.mp3 | 5/23/11 12:24 PM | 75.9.73.155 | 63460 |
| | e06a7c283698 | | | | | |
| 5 | GB-e2db0c93-2345-4aaf-b2aa- | here i am | Air Supply - Here I Am.mp3 | 5/23/11 12:24 PM | 75.9.73.155 | 63460 |
| | d0594f0f4f10 | | | | | |
| 6 | GB-b4f3a7b1-4652-4c91-b5f9- | the power of love | Air Supply - The Power Of | 5/23/11 12:24 PM | 75.9.73.155 | 63460 |
| | d94d94387726 | | Love.mp3 | | | |
| 7 | GB-88ab0a85-b441-4a8f-8305- | lonely is the night | Air Supply - Lonely is the | 5/23/11 12:24 PM | 75.9.73.155 | 63460 |
| | fa3f804763dc | | night.mp3 | | | |
| 8 | GB-53fe2596-4e8c-46db-88f3- | every woman in the | Air Supply - Every Woman In the | 5/25/11 12:57 PM | 75.9.73.155 | 63460 |
| | 370970f4bbce | world | World.mp3 | | | |
| 9 | GB-2ae0a505-2642-422f-81b6- | goodbye | Air Supply - Goodbye.mp3 | 5/25/11 12:57 PM | 75.9.73.155 | 63460 |
| | f25f9232bd69 | | | | | |
| 10 | GB-907674ea-bf60-4ce8-80ef- | just as i am | Air Supply - Just As I Am.mp3 | 5/25/11 12:57 PM | 75.9.73.155 | 63460 |
| | 40e7fa13e084 | | | | | |
| 11 | GB-0c29344c-41d9-4f57-9b5c- | even the nights are | Air Supply - Even The Nights Are | 5/25/11 12:57 PM | 75.9.73.155 | 63460 |
| | a0a8155c9c12 | better | Better.mp3 | | | |
| 12 | GB-4cee17eb-5b28-434d-814b- | the one that you | Air Supply - The One That You | 5/25/11 12:57 PM | 75.9.73.155 | 63460 |
| | 3c1dfebd5be4 | love | Love.mp3 | | | |
| 13 | GB-4aefed32-3ba6-4204-9aaf- | all out of love | Air Supply - All Out of Love.mp3 | 5/25/11 12:57 PM | 75.9.73.155 | 63460 |
| | fdac4f7b9328 | | | | | |
| 14 | GB-70abcbfb-1459-45dc-83e5- | sweet dreams | Air Supply - Sweet Dreams.mp3 | 5/25/11 12:57 PM | 75.9.73.155 | 63460 |
| | 2686c0c7165c | | | | | |
| 15 | GB-0cb4fa57-dbf1-4c0b-9579- | lost in love | Air Supply - Lost In Love.mp3 | 5/25/11 12:57 PM | 75.9.73.155 | 63460 |
| | 3a250cfe50ec | | | | | |
| 16 | GB-c4563c81-8e52-4f88-ab6b- | making love out of | Air Supply - Making Love Out of | 5/25/11 12:57 PM | 75.9.73.155 | 63460 |
| | 73a3a86a34de | nothing at all | Nothing At All.mp3 | | | |
| 17 | GB-1633f76d-6bc7-44b5-a526- | two less lonely | Air Supply - Two Less Lonely | 5/25/11 12:57 PM | 75.9.73.155 | 63460 |
| | 21f564dfaefc | people in the world | People In The World.mp3 | | | |
| 18 | GB-87ff6ee5-9e5a-484f-8e60- | young love | Air Supply - Young Love.mp3 | 5/25/11 12:57 PM | 75.9.73.155 | 63460 |
| | 8a68a277c8bd | | | | | |
| 19 | GB-ff8b0517-2480-4f45-8420- | here i am | Air Supply - Here I Am.mp3 | 5/25/11 12:57 PM | 75.9.73.155 | 63460 |
| | 97c28235eab0 | | | | | |
| 20 | GB-ea7ab0e5-264f-4eeb-8071- | the power of love | Air Supply - The Power Of | 5/25/11 12:57 PM | 75.9.73.155 | 63460 |
| | 63d2f0da9f04 | | Love.mp3 | | | |
| 21 | GB-c782705c-0b9b-4138-881f- | lonely is the night | Air Supply - Lonely is the | 5/25/11 12:57 PM | 75.9.73.155 | 63460 |
| | 4f359e4255d3 | | night.mp3 | | | |
| 22 | GB-5d2d1c06-cfd4-4bac-9f09- | every woman in the | Air Supply - Every Woman In the | 6/12/11 9:07 AM | 75.9.73.155 | 63460 |
| | 0e428b6ca49f | world | World.mp3 | | | |
| 23 | GB-60899d15-cd3d-40dc-a33f- | goodbye | Air Supply - Goodbye.mp3 | 6/12/11 9:07 AM | 75.9.73.155 | 63460 |
| | d7846f1ec384 | | | | | |
| 24 | GB-f6af7108-5920-4105-a0c2- | just as i am | Air Supply - Just As I Am.mp3 | 6/12/11 9:07 AM | 75.9.73.155 | 63460 |
| | 2f2f178ff61e | | | | | |
| 25 | GB-412b5ec7-ecc9-435d-a68d- | even the nights are | Air Supply - Even The Nights Are | 6/12/11 9:07 AM | 75.9.73.155 | 63460 |
| | 756113fa16c8 | better | Better.mp3 | | | |
| 26 | GB-60548f2d-a4a4-4e79-982a- | the one that you | Air Supply - The One That You | 6/12/11 9:07 AM | 75.9.73.155 | 63460 |
| | 336ab429a120 | love | Love.mp3 | | | |
| 27 | GB-7cddd798-9563-474d-af15- | all out of love | Air Supply - All Out of Love.mp3 | 6/12/11 9:07 AM | 75.9.73.155 | 63460 |
| | fcda779127fe | | | | | |
| 28 | GB-beb9929d-ce41-4341-b112- | sweet dreams | Air Supply - Sweet Dreams.mp3 | 6/12/11 9:07 AM | 75.9.73.155 | 63460 |
| | 7df150b8349e | | | | | |
| 29 | GB-173bba2b-8dbc-4961-9eb4- | lost in love | Air Supply - Lost in Love.mp3 | 6/12/11 9:07 AM | 75.9.73.155 | 63460 |
| | 17f5fb20f318 | | | | | |
| 30 | GB-d6c24553-ec2a-458e-9b24- | making love out of | Air Supply - Making Love Out of | 6/12/11 9:07 AM | 75.9.73.155 | 63460 |
| | 38f0d5381cd4 | nothing at all | Nothing At All.mp3 | | | |
| 31 | GB-3c6733b8-c6ed-494a-8d88- | two less lonely | Air Supply - Two Less Lonely | 6/12/11 9:07 AM | 75.9.73.155 | 63460 |
| | 3062100c9e04 | people in the world | People In The World.mp3 | | | |
| 32 | GB-899d05dc-1aa0-40cb-869c- | young love | Air Supply - Young Love.mp3 | 6/12/11 9:07 AM | 75.9.73.155 | 63460 |
| | 34dd141293bd | | | | | |
| 33 | GB-468c93a8-8d57-40b2-85e2- | here i am | Air Supply - Here I Am.mp3 | 6/12/11 9:07 AM | 75.9.73.155 | 63460 |
| | de90cf3ca0e5 | | | | | |
| 34 | GB-070748b4-87bc-41e3-8767- | the power of love | Air Supply - The Power Of | 6/12/11 9:07 AM | 75.9.73.155 | 63460 |
| | 5268bbd675ba | | Love.mp3 | | | |
| 35 | GB-9d384b80-f6f6-40d7-9cfd- | lonely is the night | Air Supply - Lonely is the | 6/12/11 9:07 AM | 75.9.73.155 | 63460 |
| | a204af21e9f7 | | night.mp3 | | | |
| 36 | GB-1baea34d-74eb-4916-8119- | every woman in the | Air Supply - Every Woman In the | 6/23/11 1:29 AM | 75.9.73.155 | 63460 |
| | 57a059c68ebd | world | World.mp3 | | | |
| 37 | GB-7dc63e89-34c1-409c-b402- | goodbye | Air Supply - Goodbye.mp3 | 6/23/11 1:29 AM | 75.9.73.155 | 63460 |
| | 869cf10938f8 | | | | | |
| 38 | GB-b526ade9-248a-4d4c-91fc- | just as i am | Air Supply - Just As I Am.mp3 | 6/23/11 1:29 AM | 75.9.73.155 | 63460 |
| | 932f25c6b1d8 | | | | | |
| 39 | GB-f343cabe-6184-4476-af28- | even the nights are | Air Supply - Even The Nights Are | 6/23/11 1:29 AM | 75.9.73.155 | 63460 |
| | 7400b3c5e9ac | better | Better.mp3 | | | |
| 40 | GB-bcf01917-5760-440e-bf79- | the one that you | Air Supply - The One That You | 6/23/11 1:29 AM | 75.9.73.155 | 63460 |
| | ad47031b5a60 | love | Love.mp3 | | | |
| 41 | GB-5a349997-cd70-43e7-a632- | all out of love | Air Supply - All Out of Love.mp3 | 6/23/11 1:29 AM | 75.9.73.155 | 63460 |
| | 1525b79142f3 | | | | | |
| 42 | GB-c26d4f12-7f0a-4197-a1bb- | sweet dreams | Air Supply - Sweet Dreams.mp3 | 6/23/11 1:29 AM | 75.9.73.155 | 63460 |
| | 0c67f36aa535 | | | | | |
| 43 | GB-39675430-27fc-4ca7-9c1f- | lost in love | Air Supply - Lost in Love.mp3 | 6/23/11 1:29 AM | 75.9.73.155 | 63460 |
| | f22078098417 | | | | | |

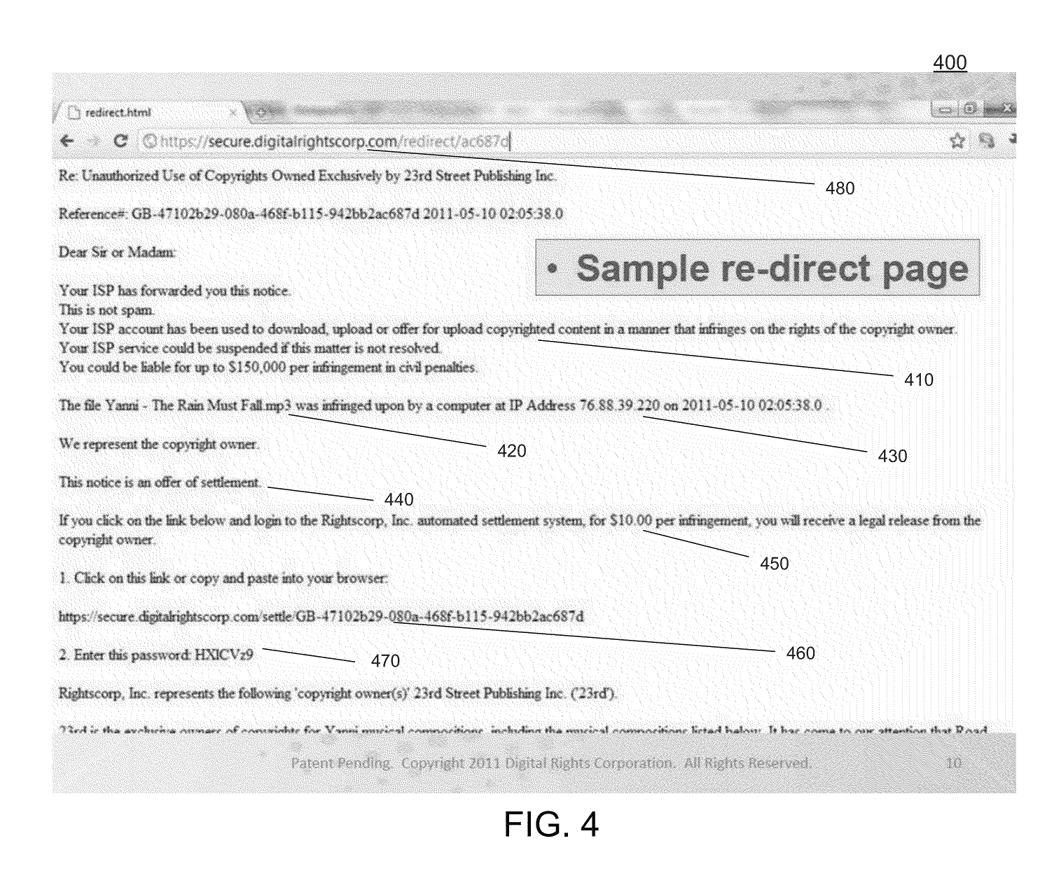

FIG. 4 shows an example of a redirect webpage 400 that may be provided to the user of an infringing computer if, e.g., the ISP determines at step 340 that the user's request for Internet access should be redirected. The ISP may determine to redirect a request for Internet access for a plurality of different reasons. The ISP may determine to redirect a request for Internet access because, e.g., the ISP has received an infringement notification indicating that a computer for node) associated with the ISP has been associated with an act of copyright infringement.

Alternatively, or in addition, the ISP may determine to redirect a request for Internet access because, e.g., the ISP has received a subsequent infringement notice suggesting that the ISP should redirect any requests for Internet access received by a user of a computer, or other node, associated with an act of copyright infringement.

Alternatively, the ISP may determine to redirect a request for Internet access because, e.g., the ISP has independently determined that the user of a computer is associated with an act of copyright infringement. However, one of ordinary skill in the art will appreciate that the disclosure is not limited to such examples. As a result, it will be readily apparent to one of ordinary skill in the art that an ISP may determine to redirect a request for Internet access for any reason that falls within the spirit and scope of the disclosure.

Redirect webpage 400 may include general information 410 associated with redirect webpage and the act of infringement. The redirect webpage 400 may include at least a portion of the infringement data. For example, the redirect webpage 400 may include information identifying the copyrighted work that was infringed 420. The redirect webpage 400 may include information identifying the infringing computer and/or the user associated with the infringing computer 430. Information that identifies the infringing computer and/or the user associated with the infringing computer may include, e.g., an IP address, a port number, a timestamp, a user ID, or the like. The redirect webpage 400 may include notice of a settlement offer to resolve the act of copyright infringement 440. The redirect webpage 400 may provide notice of a predetermined payment amount 450, that if satisfied, would settle and resolve the infringement. The predetermined payment amount may include, e.g., a flat fee (e.g., $10, $20, $100, or any other amount deemed to be acceptable by, e.g., the copyright owner).

The redirect webpage 400 is not limited to only including the portions of the infringement data provided above. Instead, the redirect webpage 400 may be configured to include any portion of the infringement data within the redirect webpage 400. As a result, the redirect webpage 400 may also include one or more of, e.g., a software version of the peer-to-peer software used to download (or upload) the copyrighted material, historical information associated with the computer associated with the act of infringement, and/or an ISP identifier.

The redirect webpage 400 may also include a link 460 associated with a payment website to resolve an outstanding infringement. The redirect webpage 400 may be configured to receive selection of the link. In response, the user may be provided access to a settlement resolution module. The settlement resolution module may be configured to accept payment from a user associated with an act of infringement for an amount equal to, e.g., the predetermined payment amount. Access to the settlement resolution module may require the use of a password 470. The password 470 may be provided by the redirect webpage 400.

The redirect webpage 400 may be generated and maintained by, e.g., the server 140 (shown in FIG. 1). After an ISP 160 (shown in FIG. 1) determines to redirect a user's request for Internet content at step 340, the ISP 160 may redirect the request for Internet content to the redirect webpage 400 that is associated with the particular infringing computer 110. The ISP 1160 may continue to, e.g., indefinitely redirect the infringing computer 110 to the redirect webpage 400 on the server 140 until the infringer has settled the outstanding infringement(s) and the ISP 160 has received a settlement confirmation notice for the outstanding infringement(s) at step 345 (shown in FIG. 3C). Further, until the settlement confirmation notice is received from the server 140, the infringing computer 110 may be prevented from accessing any other site on the Internet, except for the redirect webpage 400.

Alternatively, or additionally, the infringing computer 110 may be redirected to one or more Department of Justice webpages related to civil and/or criminal penalties for acts of copyright infringement.

Alternatively, the Internet service being provided to an infringing computer may be suspended by the ISP at step 370. In the event that the ISP suspends Internet service being provided to an infringing computer, the service may remain suspended until the infringer has settled the outstanding infringement(s) and the ISP has received a settlement confirmation notice for the outstanding infringement(s) at step 345.

Further, the redirect webpage 400 may be generated and maintained by the ISP 160 or a customer 170 (shown in FIG. 1).

FIGS. 1-4 have generally described examples of the disclosure directed to identifying an act of copyright infringement or identifying repeat infringers, based on, e.g., an IP address-port number combination. Such examples are particularly useful during a window of time when a user's IP address remains static. However, a user may rotate his/her IP address. IP address rotation refers to the dynamic changing of a user's IP address in order to bypass a network blocking mechanism, to avoid detection for file sharing, or otherwise provide a user with the opportunity to remain anonymous while the user is accessing a network. IP address rotation may be performed by changing one or more numbers in a user's IP address. IP address rotation may be achieved manually or automatically, e.g., at fixed time intervals, random time intervals, etc.

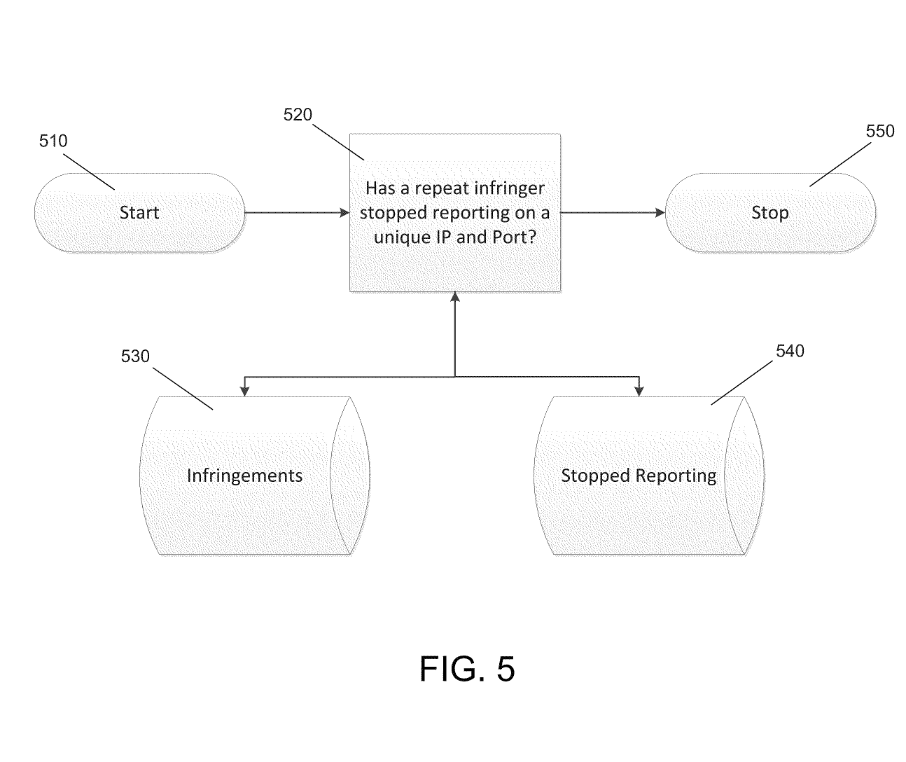

According to another aspect of the disclosure, a method is provided that may accurately identify repeat infringers who have changed their IP address. The method may include one or more aspects of the port matching method described in FIGS. 5-11.

FIG. 5 discloses a method that starts at step 510. The system 100 (shown in FIG. 1) determines whether a previously identified repeat infringer has stopped reporting acts of infringement identifiable by a unique IP address-port combination at 520. System 100 (shown in FIG. 1) may perform this determination by analyzing data maintained in one or more data structures within Infringements data store 530 and Stopped Reporting data store 540, which may be stored in the database(s) 150 or server 140 (shown in FIG. 1). A data store may be, e.g., a data structure, a database, a flat file, or any other organized grouping of data.

The Infringements data store 530 may include one or more data structures storing one or more acts of copyright infringement associated with one or more computer identifiers. The Infringement data store 530 may be dynamically updated in order to dynamically detect and record acts of infringement associated with a particular identifier, thereby allowing for the creation of a dynamic list that continuously updates as new acts of infringement are identified and associated with a particular identifier. The identifier and associated acts of copyright infringement may therefore be used to identify repeat infringers. The identifier may be, e.g., an IP address-port number combination.

Generally, system 100 (shown in FIG. 1) may continue to associate acts of infringement with an identifier stored in the Infringement data store 530 as the acts of infringement continue to occur over time. However, when a predetermined amount of time has passed without an act of infringement associated with a particular identifier, the system 100 (shown in FIG. 1) may trigger the creation of a record in a data structure in the Stopped Reporting data store 540. The Stopped Reporting data store 540 maintains a data structure that stores computer identifiers for previously identified repeat infringers for which an act of infringement has not been reported within a predetermined period of time (e.g., days, weeks, months, years, etc.). An act of infringement may be reported, e.g., when a user adds copyrighted content to a user's shared folder, thereby making the copyrighted content available to other peer computers.

The system 100 (shown in FIG. 1) may determine whether a repeat infringer stopped reporting acts of infringement associated with a unique IP address-Port number combination, e.g., by consulting the Infringements data store 530 and the Stopped Reporting data store 540. System 100 (shown in FIG. 1) may conclude that a repeat infringer has stopped reporting acts of infringement if, e.g., a repeat infringer has not added copyrighted content to the repeat infringer's shared folder within a predetermined period of time. Such a repeat infringer may be referred to herein as a stopped reporting repeat infringer.

A repeat infringer may stop reporting acts of infringement associated with a unique IP address-port number combination because the repeat infringer's IP address has dynamically changed, thereby resulting in a different IP address-port number combination being associated with the repeat infringer's computer. If a conclusion is reached at step 520 that a repeat infringer has stopped reporting acts of infringement associated with a unique IP address-port number combination, then the process disclosed by FIG. 5 ends at step 550.

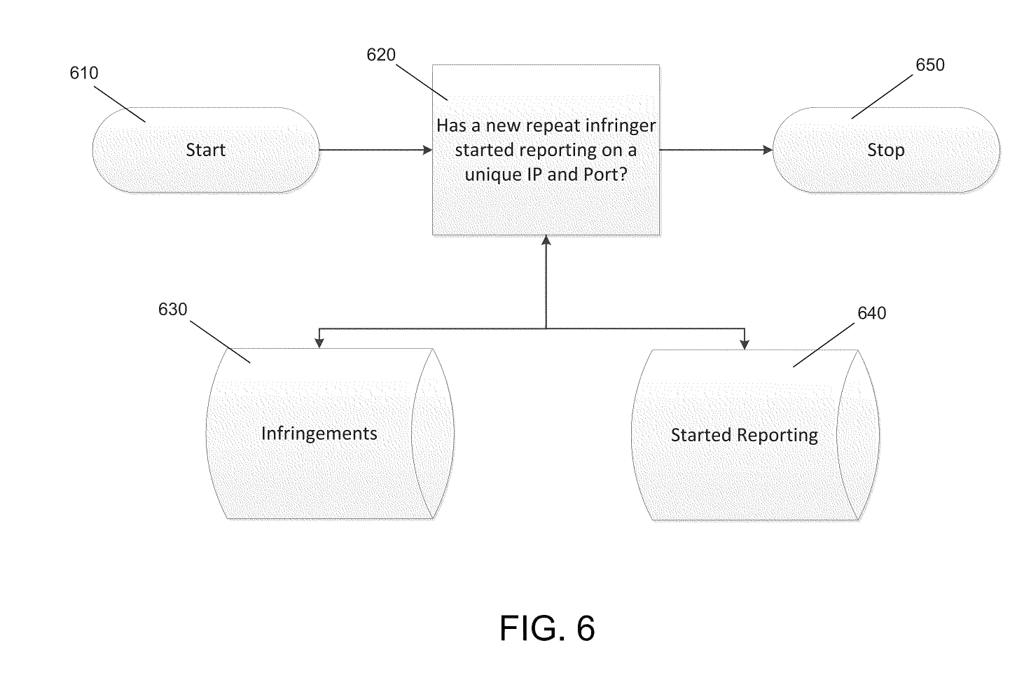

The end of the process set forth in FIG. 5 may trigger the beginning of the process disclosed in FIG. 6. FIG. 6 discloses a process that starts at step 610. The system 100 (shown in FIG. 1) determines whether a new, or previously unidentified, repeat infringer has started reporting acts of infringement associated with a unique IP address-port combination at 620. System 100 (shown in FIG. 1) may perform this determination by analyzing data maintained in one or more data structures within Infringements data store 630 and Started Recording data store 640, which may be stored in the database(s) 150 or server 140 (shown in FIG. 1).

The Infringements data store 630 may be substantially the same data store as Infringements data store 530. Alternatively, the Infringements data store 630 may be a different data store than Infringements data store 530. Infringements data store 630 may include one or more data structures storing one or more acts of copyright infringement associated with one or more computer identifiers. The Infringement data store 630 may be dynamically updated in order to dynamically detect and record acts of infringement associated with a particular identifier, thereby allowing for the creation of a dynamic list that continuously updates as new acts of infringement are identified and associated with a particular identifier. The identifier and associated acts of copyright infringement may therefore be used to identify repeat infringers. The identifier may be, e.g., an IP address-Port number combination.

Generally, system 100 (shown in FIG. 1) may continue to associate acts of infringement with an identifier stored in the Infringement data store 630 as the acts of infringement continue to occur over time. However, when a new, or previously unidentified, repeat infringer is detected, the system 100 (shown in FIG. 1) may trigger the creation of a record in a data structure in the Started Reporting data store 640. The Started Reporting data store 640 maintains a data structure that stores computer identifiers for new, or previously unidentified, repeat infringers. An act of infringement may be reported, e.g., when a user adds copyrighted content to a user's shared folder, thereby making the copyrighted content available to other peer computers.

The system 100 (shown in FIG. 1) may determine whether a new, or previously unidentified, repeat infringer has started reporting acts of infringement associated with a unique IP address port number combination, e.g., by consulting the Infringements data store 630 and the Started Reporting data store 640. The system 100 (shown in FIG. 1) may conclude that a repeat infringer has started recording acts of infringement if, e.g., a repeat infringer with a new, or previously unidentified IP address-port number combination has added copyrighted content to the repeat infringer's shared folder within a predetermined period of time. Such a repeat infringer may be referred to herein as a started reporting repeat infringer. If a conclusion is reached at step 620 that a new, or previously unidentified, repeat infringer has started reporting acts of infringement associated with a unique IP address-Port number combination, then the process disclosed by FIG. 6 ends at step 650.

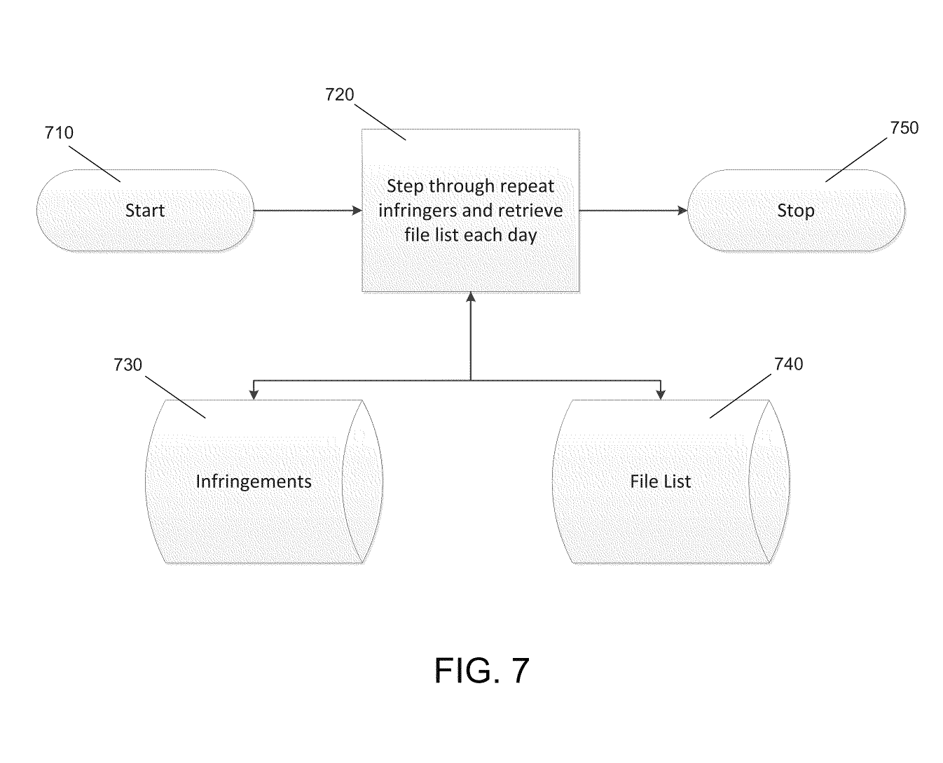

The execution of the process generally described in FIG. 5 may result in the identification of a stopped reporting repeat infringer. The execution of the process generally described in FIG. 6 may result in the identification of a started reporting repeat infringer. When such identifications occur, the process generally described in FIG. 7 may be triggered.

FIG. 7 discloses a method that starts at step 710. The system 100 (shown in FIG. 1) may process a data structure that maintains a list of previously identified repeat infringers at 720. System 100 (shown in FIG. 1) may perform the process at 720, e.g., by consulting data maintained in one or more data structures within Infringements data store 730 and File List data store 740, which may be stored in the database(s) 150 or server 140 (shown in FIG. 1).

The Infringements data store 730 may be substantially the same data store as infringements data stores 530 and 630. Alternatively, the Infringements data store 730 may be a different data store than Infringements data stores 530 and 630. Infringements data store 730 may include one or more data structures storing one or more acts of copyright infringement associated with one or more computer identifiers. The Infringement data store 730 may be dynamically updated in order to dynamically detect and record acts of infringement associated with a particular identifier, thereby allowing for the creation of a dynamic list that continuously updates as new acts of infringement are identified and associated with a particular identifier. The identifier and associated acts of copyright infringement may therefore be used to identify repeat infringers. The identifier may be, e.g., an IP address-port number combination.

Generally, one or more repeat infringers may add one or more copyrighted files to a shared folder. The shared folder may be configured in a manner that allows the contents of the shared folder to be shared with other members of the peer-to-peer network. A list of the contents of a computer's shared folder may be maintained in, e.g., File List data store 740.

File List data store 740 may be organized in a manner that distinguishes lists of shared folder contents of different types of users and/or computers. For example, there may be a portion of the data store designated to store shared folder content lists associated with stopped reporting repeat infringers and a portion of the data store designated to store shared folder content lists associated with started reporting repeat infringers. The File List data store 740 may maintain a log of the contents of a particular shared folder during a particular time period. The time period may measured in, e.g., seconds, minutes, hours, days, weeks, etc.

The system 100 (shown in FIG. 1) may determine the precise contents of a user's shared folder on any particular day by, e.g., consulting the Infringements data store 730 and the File List data store 740 in step 720. For example, Table 3 illustrates an example of the contents of a repeat infringer's shared folder as it existed on May 27, 2011.

TABLE 3

| | | | | | |
|---|---|---|---|---|---|
| 32-20 blues | Robert Johnson - 32-20 Blues.mp3 | 2788044 | 5/24/11 4:35 | 98.149.93.203 | 30366 |
| | | | AM | | |
| come on in my | Robert Johnson - Come On In My Kitchen | 2747663 | 5/24/11 4:35 | 98.149.93.203 | 30366 |
| kitchen | (1936).mp3 | | AM | | |
| love in vain | robert johnson - love in vain blues.mp3 | 2427214 | 5/24/11 4:35 | 98.149.93.203 | 30366 |
| | | | AM | | |
| terraplane blues | Robert johnson - Terraplane Blues.mp3 | 3574061 | 5/24/11 4:35 | 98.149.93.203 | 30366 |
| | | | AM | | |
| walking blues | Robert Johnson - Walking Blues.mp3 | 2420736 | 5/24/11 4:35 | 98.149.93.203 | 30366 |
| | | | AM | | |
| black dog | Led Zeppelin - Black Dog.mp3 | 4721266 | 5/27/11 7:55 | 98.149.93.203 | 30366 |
| | | | AM | | |
| good times bad | Led Zeppelin - Good Times Bad | 2659142 | 5/27/11 7:55 | 98.149.93.203 | 30366 |
| times | Times.mp3 | | AM | | |
| rock and roll | Led Zeppelin - Rock And Roll.mp3 | 3534262 | 5/27/11 7:55 | 98.149.93.203 | 30366 |
| | | | AM | | |
| stairway to | led zeppelin - stairway to heaven.mp3 | 7714143 | 5/27/11 7:55 | 98.149.93.203 | 30366 |
| heaven | | | AM | | |
| whole lotta love | led zepplin - led zeppelin ii - whole lotta | 5349002 | 5/27/11 7:55 | 98.149.93.203 | 30366 |
| | love.mp3 | | AM | | |

Table 3 shows the various types of data that may be associated with the contents of a repeat infringer's shared folder that may be maintained in the File List data store 740. The File List data store 740 may include, e.g., the title of the content, the artist of the content, the date the content was added to the shared folder, the IP address of the computer that acquired the content, the port number of the computer that acquired the content, or the like. In the example in the table displayed above, the IP address-port Number combination identifier of the repeat infringer associated with this particular shared folder is, e.g., IP address 98.149.93.203 and port number 30366.

Similarly, a subsequent inquiry into the contents of File List data store 740 may yield a different file list. For instance, Table 4 displays an example of the contents of a shared folder on Jun. 24, 2011, as shown below for a repeat infringer with an IP address port number combination of, e.g., IP address 98.149.93.42, port 30366:

TABLE 4

| | | | | | |
|---|---|---|---|---|---|
| black dog | Led Zeppelin - Black Dog.mp3 | 4721266 | 6/14/11 8:54 AM | 98.149.93.42 | 30366 |
| good times bad | Led Zeppelin - Good Times Bad | 2659142 | 6/14/11 8:54 AM | 98.149.93.42 | 30366 |
| times | Times.mp3 | | | | |
| rock and roll | Led Zeppelin - Rock And Roll.mp3 | 3534262 | 6/14/11 8:54 AM | 98.149.93.42 | 30366 |
| stairway to | led zeppelin - stairway to heaven.mp3 | 7714143 | 6/14/11 8:54 AM | 98.149.93.42 | 30366 |
| heaven | | | | | |
| whole lotta love | led zepplin - led zeppelin ii - whole lotta | 5349002 | 6/14/11 5:54 AM | 98.149.93.42 | 30366 |
| | love.mp3 | | | | |
| black dog | Led Zeppelin - Black Dog.mp3 | 4721266 | 6/23/11 11:26 AM | 98.149.93.42 | 30366 |
| good times bad | Led Zeppelin - Good Times Bad | 2659142 | 6/23/11 11:26 AM | 98.149.93.42 | 30366 |
| times | Times.mp3 | | | | |
| rock and roll | Led Zeppelin - Rock And Roll.mp3 | 3534262 | 6/23/11 11:26 AM | 98.149.93.42 | 30366 |
| stairway to | led zeppelin - stairway to heaven.mp3 | 7714143 | 6/23/11 11:26 AM | 98.149.93.42 | 30366 |
| heaven | | | | | |
| whole lotta love | led zepplin - led zeppelin ii - whole lotta | 5349002 | 6/23/11 11:26 AM | 98.149.93.42 | 30366 |
| | love.mp3 | | | | |
| 32-20 blues | Robert Johnson - 32-20 Blues.mp3 | 2788044 | 6/24/11 5:36 AM | 98.149.93.42 | 30366 |
| come on in my | Robert Johnson - Come On In My Kitchen | 2747663 | 6/24/11 5:36 AM | 98.149.93.42 | 30366 |
| kitchen | (1936).mp3 | | | | |
| love in vain | robert johnson - love in vain blues.mp3 | 2427214 | 6/24/11 5:36 AM | 98.149.93.42 | 30366 |
| terraplane blues | Robert johnson - Terraplane Blues..mp3 | 3574061 | 6/24/11 5:36 AM | 98.149.93.42 | 30366 |
| walking blues | Robert Johnson - Walking Blues.mp3 | 2420736 | 6/24/11 5:36 AM | 98.149.93.42 | 30366 |

System 10 (shown in FIG. 1) may therefore query File List data store 740 in order to obtain one or more lists representing the contents of a repeat infringer's shared folder. For example, a query may request a list of the contents of a repeat infringer's shared folder for a particular day. The query may alternatively request, e.g., a list of the contents of a repeat infringer's shared folder as it existed on each individual day in a given month. In addition, the query may request two different lists representing the shared folder of two different repeat infringers. The two different repeat infringers may be, e.g., a stopped reporting repeat infringer and a started reporting repeat infringer. System 100 (shown in FIG. 1) may obtain the lists described above by submitting a query that includes an identifier such as, e.g., an IP address-port number combination.

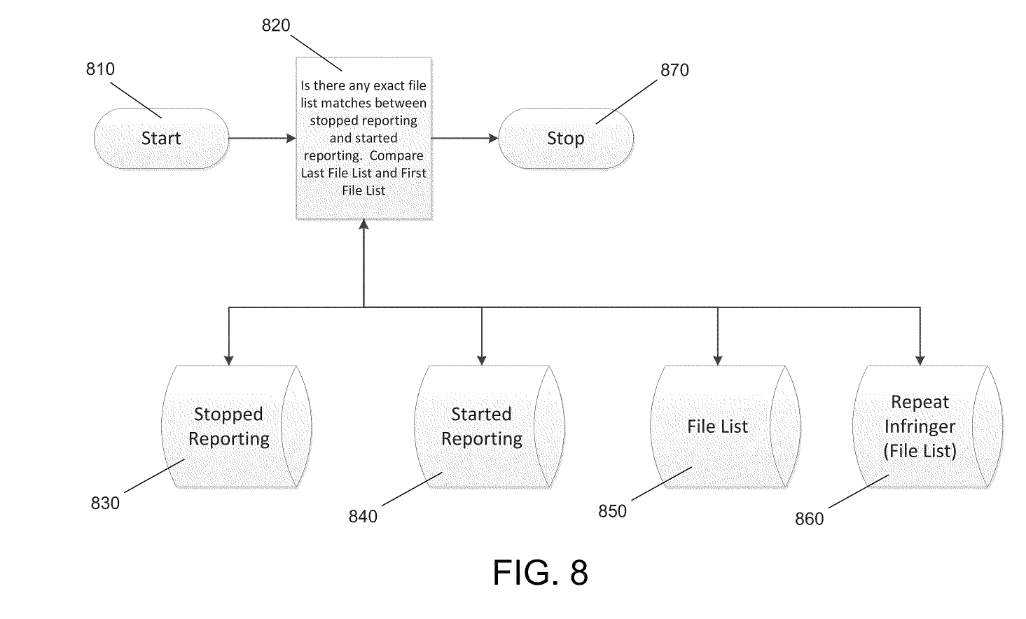

FIG. 8 discloses an embodiment of a method that provides a solution to the problem of repeat infringers' rotating their IP addresses. The process beings at step 810. The system 100 (shown in FIG. 1) determines whether two different IP address-port number combinations are associated with the same repeat infringer at step 820. System 100 (shown in FIG. 1) may perform this determination by analyzing data maintained in one or more data structures within Stopped Reporting data store 830, Started Recording data store 840, File List data store 850, and/or Repeat infringer File List data store 860, all (or some) of which may be stored in the database(s) 150 or server 140 (shown in FIG. 1).

The system 100 may query the Stopped Reporting data store 830 at 820 in order to determine a list of stopped reporting repeat infringers. The system 100 may also query the Started Reporting data store in order to determine a list started reporting repeat infringers. Utilizing the data retrieved from the Stopped Reporting data store 830 and Started Reporting data store 840, the system 100 (shown in FIG. 1) may query Repeat Infringer File List data store 860 and File List data store 850 in order to retrieve the shared folder contents associated with each of the results returned from Stopped Reporting data store 830 and Started Reporting data store 840.

The results returned from the query directed to the File List data stores 850 and 860 may lead to the generation of one or more data structures. The first data structure may include a list of stopped reporting repeat infringers that may be associated with a list representative of the contents of the stopped reporting repeat infringer's shared folder during a predetermined time period. The second data structure may include a list of started reporting repeat infringers that may be associated with a list representative of the contents of the started reporting repeat infringer's shared folder during a predetermined time period.

The system 100 may proceed at 820 to compare each stopped reporting repeat infringer's shared folder content list in the first data structure with each shared folder content list associated with a started reporting repeat infringer in the second data structure. If a substantially equivalent file list is detected, it may be determined that the stopped reporting repeat infringer and the started reporting repeat infringer are using the same computer. If a less than exact match occurs, it may be concluded that the two repeat infringers are not using the same computer or a more detailed forensic analysis of data associated with each computer may be performed as described herein below.

While the process described above may compare the contents of a computer's shared folder in order to determine if two different IP address-port number combinations belong to the same user, it should be readily understood that the present disclosure is not so limited. For instance, in view of the present disclosure, it will be understood by one of ordinary skill in the art that any data that is associated with a client computer could be used in order to determine if two different IP address-port number combinations actually belong to the same computer. For example, process 820 could compare infringement data, names of the software used to share the copyrighted content, version number of the software used to share the copyrighted content, and/or transmission packet information in order to give additional credibility to the determination that two different IP address-port number combinations identify the same computer or repeat infringer.

The process in FIG. 5 provides a solution to the problem of repeat infringers avoiding detection by rotating their IP address by comparing data sets as described herein. However, other aspects of the disclosure may provide for a more detailed forensic analysis of data associated with a repeat infringer's computer.

The system 100 may perform a forensic process that includes a deeper forensic analysis of data associated with a repeat infringer's computer by applying one or more existing machine learning algorithms, such as, e.g., but not limited to, a Bayesian Network Classifier.

The forensic process may include teaching the algorithm (e.g., Bayesian Network Classifier) with at least a portion of a known data set. For example, in accordance with one aspect of the disclosure, one may input a portion of gathered data that is known to identify, e.g., one or more particular stopped reporting repeat infringers. This teaching data may include, e.g., a stopped reporting repeat infringer's IP address port number combination, infringement data, names of the software used to share the copyrighted content, version number of the software used to share the copyrighted content, transmission packet information, or any other data that may be associated with the description of a stopped reporting repeat infringer's computer. After being taught with this training data, a machine learning algorithm may be endowed with a knowledge base that the machine learning algorithm can consult in order to make accurate predictions regarding future input data sets associated with a started reporting repeat infringer with a certain degree of probability.

The forensic process may then apply the trained machine learning algorithm to an input data set that may be, e.g., associated with a started reporting repeat infringer. For example, a data set associated with a started reporting repeat infringer may be fed into the machine language algorithm. The machine learning algorithm may receive the input data set associated with a started reporting repeat infringer and determine a probability that, based at least in part on the trained data set associated with one or more stopped reporting repeat infringers, the input data set falls within a particular category.

The forensic process may then sort through and interpret the results of the machine learning algorithm. The results, or output, of the machine learning algorithm may include, e.g., a probability that an input data set falls within one of a plurality of categories. In other words, an output may be provided that indicates, e.g., the likelihood that the stopped reporting repeat infringer and the started reporting repeat infringer are using the same computer.

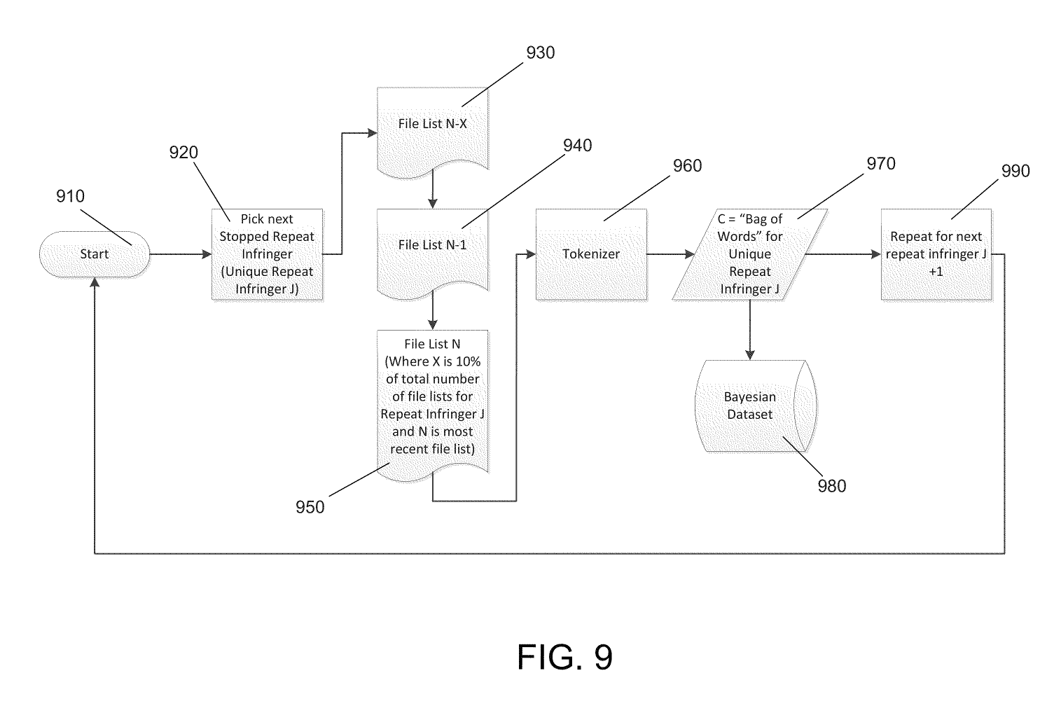

FIGS. 9-11 each provide a description of applying each step of the machine learning process to the problem of repeat infringers avoiding detection by rotating their IP address that relies upon a simple comparison of data sets.

FIG. 9 discloses a process of teaching a machine learning algorithm with at least a portion of a known data set, which may be employed by the system 100 (shown in FIG. 1). The process of teaching a machine learning algorithm may include, e.g., populating a data set associated with a machine algorithm. The process of FIG. 9 begins at 910. At 920, the process may select a stopped reporting repeat infringer from a list of stopped reporting repeat infringers. The stopped reporting repeat infringer may be selected, e.g., from the first data structure created in process 820.

At 930, 940, and 950, the process may select a training input data set that may be used to train the machine learning algorithm. The training input may be, e.g., a subset of the total number of shared folder file lists (hereinafter “file lists”) associated with a particular stopped reporting repeat infringer. One aspect of the present disclosure provides that the training input may be, e.g., 10% of the total number of file lists associated with a particular stopped reporting repeat infringer. The training input may also be, e.g., selected from the most recently obtained file lists associated with a stopped reporting repeat infringer. Selecting the most recent file lists may be advantageous because it is likely that the contents of the file list associated with a stopped reporting repeat infringer will be substantially equivalent to the file list of a started reporting repeat infringer at, or near, the time of an IP address rotation.

In accordance with one aspect of the disclosure, the system 100 (shown in FIG. 1) may, e.g., maintain file lists for a stopped reporting repeat infringer for N=90 days. During this time period a file list may be saved, e.g., once per day for 90 days. In accordance with this example, the most recent 10% of the stopped reporting repeat infringer's the list may be, e.g., a file list saved on day 90 (e.g., 3/31), a file list saved on day 89 (e.g., 3/30), a file list recorded on day 88 (e.g., 3/29), and the file list stored on day 82 (e.g., 3/22) (including all the lists stored on days between day 88 and day 82).

At 960, the files lists depicted at 930, 940, and 950, may be input into a tokenizer. The tokenizer is a conventional tokenizer as is known in the art and functions to extract all necessary data from the file lists in order to create an adequate input data set to train the machine learning algorithm. Such a tokenizer may parse the files lists depicted at 930, 940, 950, to extract, e.g., file names, artist names, IP address, Port number, or any other data that is associated with the file list and determined to facilitate training of the machine learning algorithm.

At 970, the output of the tokenizer may be organized and prepared to be used to populate a data set at 980 which may be associated with a machine learning algorithm. In accordance with one aspect of the disclosure, the output of the tokenizer may be, e.g., a bag of words and the data set may be, e.g., a Bayesian Dataset. However, the present disclosure is not so limited. For instance, in view of the present disclosure, it will be understood by one of ordinary skill in the art that the output of the tokenizer may be organized such that it could teach any data set associated with any machine learning algorithm.

After the output of the tokenizer has been organized at 970 and used to populate the data set at 980, at 990 the process may traverse back to 910 and repeat. This process may continue to repeat in the manner described above until, e.g., each entry residing within the first data structure created at 820 (shown in FIG. 8) has been processed in accordance with the process of FIG. 9.

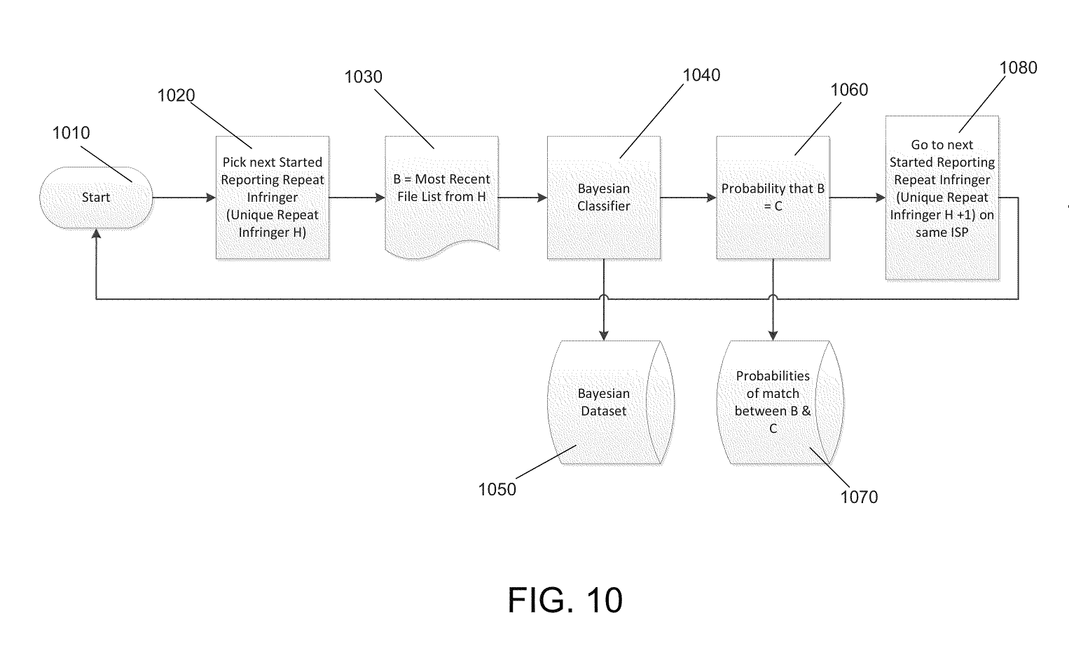

FIG. 10 discloses a process that may be carried out by the system 100 (shown in FIG. 1) to apply a machine learning algorithm to an input data set. The process of FIG. 10 begins at 1010. At 1020, the process may select a started reporting repeat infringer. The started reporting repeat infringer may be, e.g., associated with a new, or previously unidentified. IP address-port number combination. The started reporting repeat infringer may be selected, e.g., from the second data structure created at 820 in FIG. 8.

At 1030, the most recent file list associated with a started reporting repeat infringer may be selected and used to feed the machine learning algorithm. Feeding the machine learning algorithm may be achieved by, e.g., passing the most recent file list associated with a started reporting repeat infringer to the machine learning algorithm as an input data set. At 1040, a machine learning algorithm may be provided with the most recent file list associated with a started reporting repeat infringer as an input. The machine learning algorithm may then analyze the input data set in accordance with an associated trained data set 1050. The trained data set 1050 may be the same, or similar to, e.g., the data set 980 trained in FIG. 9.

At least one aspect of the present disclosure provides that the machine learning algorithm may be based at least in part on, e.g., a Bayesian Network Classification approach that may be fully automated. However, it is noted that the present disclosure is note so limited. For instance, in view of the present disclosure, it will be understood by one of ordinary skill in the art that any machine learning algorithm may be used in order to analyze a trained data set. Furthermore, while one or more aspects of the present disclosure may eliminate the need for human interaction in the process of analyzing input data sets in accordance with a trained data set, other aspects of the disclosure may invite a collaborative approach between a human and a machine when analyzing an input data set in accordance with the disclosure.

At 1060, the process may provide the results of the execution of the machine learning algorithm at 1040 after receiving the input data set described at 1030. The results may be determined by, e.g., the machine language algorithm calculating the probability that the input data set 1030 representing the file list associated with a started reporting repeat infringer is substantially equivalent to the file list associated with a stopped reporting repeat infringer that was input into the data set at 980 or at 1050. The results at 1060 may be expressed in the form of e.g., a probability. This probability may then be stored in a data structure within the Probabilities data store 1070, which may be stored in the database(s) 150 or server 140 (shown in FIG. 1).

After the output of the results of the machine learning algorithm are stored in a data structure within the Probabilities data store 1070, the process, at 1080, may traverse back to 1010 and repeat. This process may continue to repeat in the manner described above until, e.g., each entry of the second data structure created at 820 has been processed in accordance with the process of FIG. 10.

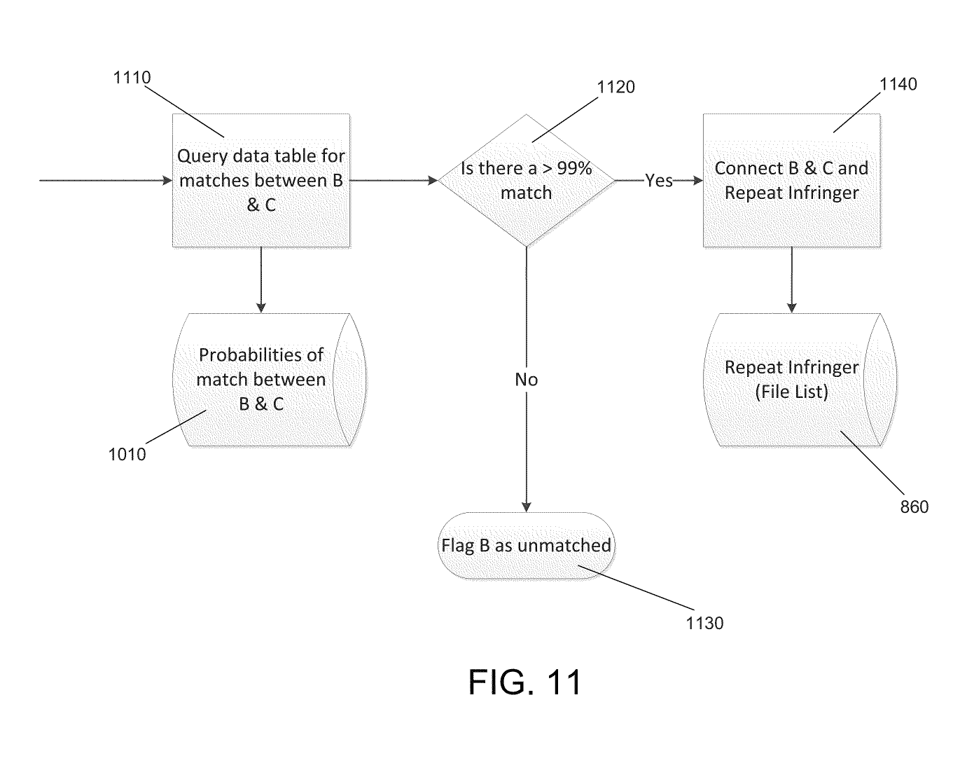

FIG. 11 discloses the process that may be carried out by the system 100 (shown in FIG. 1) in sorting through and interpreting the results of the machine learning algorithm that were processed and stored in Probabilities data store 1010. The process of FIG. 11 begins at 1110 where the system 100 (shown in FIG. 1) may query a Probabilities data store 1010 in order to retrieve the results of the machine learning algorithm that were stored in the Probabilities data store 1010. At 1120, the system 100 (shown in FIG. 1) may determine, e.g., if there is greater than, e.g., a 99% probability (or any predetermined threshold probability) of a match between the file list associated with a stopped reporting repeat infringer and the file list associated with a started reporting repeat infringer. If at 1120 it is determined, e.g., that there is not a greater than 99% probability (predetermined threshold probability) of a match between the file list associated with the stopped reporting repeat infringer and file list associated with a started reporting repeat infringer, then the system 100 (shown in FIG. 1) may record an indication at 1130 that the started reporting repeat infringer is not the same computer as the stopped reporting repeat infringer.

If, instead, at 1120 it is determined, e.g., that there is a greater than 99% probability (predetermined threshold probability) of a match between the file list associated with a stopped reporting repeat infringer and the file list associated with a started reporting repeat infringer, then the system 100 (shown in FIG. 1) may update the Repeat Infringer File List data store 860 in order to reflect that the stopped reporting repeat infringer and the started reporting repeat infringer are forensically determined to be the same computer.

According to an aspect of the disclosure, a computer readable medium is provided containing a computer program, which when executed on, e.g., the server 140, causes the processes disclosed in FIGS. 5-11 to be executed. The computer program may be tangibly embodied in the computer readable medium, comprising one or more program instructions, code segments, or code sections for performing the processes disclosed in FIGS. 5-11 when executed by, e.g., the server 140, and/or the like.

The disclosure described herein may therefore provide a method of forensically determining if two unique IP address-port number combinations are actually associated with the same computer. The application of principles of the disclosure set forth herein provides a solution to the problem of repeat infringers avoiding detection by rotating their IP address. The forensic determinations set forth herein may help to establish an evidentiary trail that may be used to obtain a subpoena in order to obtain the computer records belonging to a repeat infringer.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

What is claimed:

1. A method for forensically identifying repeat infringers, the method comprising:
teaching a machine learning algorithm with at least a portion of a first data set, wherein the first data set is associated with a stopped recording repeat infringer;
feeding the machine learning algorithm a second data set, wherein the second data set is associated with a started reporting repeat infringer; and,
determining if the stopped reporting repeat infringer and the started reporting repeat infringer are using the same computer.

2. The method of claim 1, wherein the first data set includes a file list associated with the stopped reporting repeat infringer.

3. The method of claim 1, wherein the first data set includes a subset of all file lists associated with the stopped reporting repeat infringer.

4. The method of claim 1., wherein the second data set includes a file list associated with the started reporting repeat infringer.

5. The method of claim 4, wherein the file list includes the most recent file list associated with the started reporting repeat infringer.

6. The method of claim 1, wherein the machine learning algorithm includes a Bayesian Network Classification.

7. The method of claim 1, wherein the step of determining comprises:
calculating a probability that the first data set and the second data set are substantially equivalent; and,
storing the probability in a data structure.

8. The method of claim 1, wherein the step of determining comprises:
displaying the first data set and the second data set in a split screen format.

9. A system for forensically identifying repeat infringers, comprising:
a first data gathering module configured to obtain a first file list associated with a stopped reporting repeat infringer;
a second data gathering module configured to obtain a second file list associated with a started reporting repeat infringer; and,
a comparing module configured to compare the first file list to the second file list and determine if the stopped reporting repeat infringer and the started reporting repeat infringer are using the same computer.

10. The system of claim 9, wherein the stopped reporting repeat infringer and the started reporting repeat infringer have different IP address-port number combinations.

11. The system of claim 9, the system further comprising:
a calculation module configured to calculate the probability that the first file list and the second file list are substantially equivalent.

12. The system of claim 9, the system further comprising:
a display module configured to display the first list and the second list in a split screen format.

13. A computer readable medium including instructions, which when executed by a computer, cause the computer to perform a method for forensically identifying repeat infringers, the instructions comprising:
instructions that instruct the computer to teach a machine learning algorithm with at least a portion of a first data set, wherein the first data set is associated with a stopped recording repeat infringer;
instructions that instruct the computer to feed the machine learning algorithm a second data set, wherein the second data set is associated with a started reporting repeat infringer; and,
instructions that instruct the computer to determine if the stopped reporting repeat infringer and the started reporting repeat infringer are using the same computer.

14. The computer readable medium of claim 13, wherein the first data set includes a file list associated with the stopped reporting repeat infringer.

15. The computer readable medium of claim 13, wherein the first data set includes a subset of all file lists associated with the stopped reporting repeat infringer.

16. The computer readable medium of claim 13, wherein the second data set includes a file list associated with the started reporting repeat infringer.

17. The computer readable medium of claim 16, wherein the file list includes the most recent file list associated with the started reporting repeat infringer.

18. The computer readable medium of claim 13, wherein the machine learning algorithm includes Bayesian Network Classification.

19. The computer readable medium of claim 13, wherein instructions that instruct the computer to determine further comprise:
instructions that instruct the computer to calculate a probability that the first data set and the second data set are substantially equivalent; and,
instructions that instruct the computer to store the probability in a data structure.

20. The computer readable medium of claim 13, wherein instructions that instruct the computer to determine further comprise:
instructions that instruct the computer to display the first data set and the second data set in a split screen format.
